(19) United States
(12) Patent Application Publication
(10) Pub. No.: US 2016/0150321 A1
(43) Pub. Date: May 26, 2016

(54) MICRO PHONE AND METHOD OF MANUFACTURING THE SAME

(71) Applicant: Hyundai Motor Company, Seoul (KR)

(72) Inventor: Ilseon Yoo, Seoul (KR)

(21) Appl. No.: 14/846,789

(22) Filed: Sep. 6, 2015

(30) Foreign Application Priority Data
Nov. 26, 2014 (KR) 10-2014-0166782

(51) Int. Cl. H04R 7/08; H04R 31/00; H04R 17/02

(52) U.S. Cl. CPC H04R 7/08; H04R 17/02; H04R 31/003; H04R 2201/003

(57) ABSTRACT

A microphone and method of manufacturing the microphone are provided. The method includes forming a first and second oxide film at an upper side and lower side of a substrate and sequentially forming a membrane and a first photosensitive layer pattern over the first oxide film. A vibrating membrane and fixed membrane are formed as a comb finger shape by etching the membrane with the first photosensitive layer pattern as a mask. A second photosensitive layer pattern is also formed at the second oxide. A penetration aperture is formed by etching the substrate with the second photosensitive layer pattern as a mask. Lastly, the first and second film are removed.

### CROSS-REFERENCE TO RELATED APPLICATION

This application claims priority to and the benefit of Korean Patent Application No. 10-2014-0166782 filed in the Korean Intellectual Property Office on Nov. 26, 2014, the entire contents of which are incorporated herein by reference.

### BACKGROUND

(a) Field of the Invention

The present invention relates to a microphone and a method of manufacturing the microphone and more particularly, to a microphone having a vibrating membrane and a fixed membrane formed in a common layer, and a method of manufacturing the microphone.

(b) Description of the Related Art

In general, microphones, which convert a voice into an electrical signal, have been reduced in size and accordingly, a microphone using a Micro Electro Mechanical System (MEMS) technology is being developed. The microphone using MEMS is advantageous since it has increased resistant to humidity and heat compared to a conventional Electret Condenser Microphone (ECM). Furthermore the microphone using MEMS may be downsized and integrated with a signal processing circuit.

Generally, the MEMS microphone is either a capacitance MEMS microphone or a piezoelectric MEMS microphone. Typically, the capacitance MEMS microphone includes a fixing electrode and a vibrating membrane. When a sound pressure is applied to the vibrating membrane from the exterior, the gap between the fixing electrode and the vibrating membrane changes and the capacitance is adjusted accordingly. In this process, the sound pressure is measured based on a generated an electrical signal.

Furthermore, the piezoelectric MEMS microphone includes a vibrating membrane. For example, when the vibrating membrane is deformed by the external sound pressure, an electrical signal is generated by the piezoelectric effect and the sound pressure is measured. The current applied to the MEMS microphone is predominantly in the capacitance type. In particular, in the capacitance MEMS microphone, a fixing electrode and a vibration membrane are formed using surface micromachining and bulk micromachining. However, the process for manufacturing the conventional capacitance MEMS microphone is complex, having increased the cost and the number of processes.

The above information disclosed in this section is merely for enhancement of the understanding of the background of the invention and therefore it may contain information that does not form the prior art that is already known in this country to a person of ordinary skill in the art.

### SUMMARY

The present invention provides a microphone that may be downsized at a reduced cost, which may have a vibrating membrane and fixed membrane, formed in a comb finger shape in a common layer, and may thereby measure a sound pressure through a change of an area overlapping between the vibrating membrane and fixed membrane.

According an exemplary embodiment, a method of manufacturing a microphone may include forming a first oxide film and a second oxide film at an upper side and lower side of a substrate, respectively. A membrane and a first photosensitive layer pattern may be formed over the first oxide film. A vibrating membrane and fixed membrane may be formed as a comb finger shape by etching the membrane with the first photosensitive layer pattern as a mask. A second photosensitive layer pattern may be formed at the second oxide. A penetration aperture may be formed by etching the substrate with the second photosensitive layer pattern as a mask, and removing the first oxide film and the second film. In another aspect, the vibrating membrane and the fixed membrane may be formed as a comb finger shape, the vibrating membrane and the fixed membrane may be formed in a common layer (e.g., the same layer). After the forming the vibrating membrane by etching the membrane, a method of manufacturing a microphone may include forming a first pad and a second pad respectively, connected with the fixed membrane and the vibrating membrane after removing the first photosensitive layer pattern. The penetration aperture may be configured such that air may flow therein. In some embodiments, etching the vibrating membrane may further include forming a first pad and a second pad respectively, connected with the fixed membrane and the vibrating membrane which may be formed in a comb finger shape. According another aspect, a microphone may include a substrate having at least one penetration aperture and a membrane disposed an upper side of the substrate and having a vibrating membrane and the fixed membrane which may be formed in a comb finger shape.

In another exemplary embodiment, the vibrating membrane and the fixed membrane may be formed in a comb finger, and may be disposed in the common layer. The vibrating membrane may be exposed by the penetration aperture. Additionally, the vibrating membrane may include a center portion formed in substantially center of the membrane and a plurality of first finger portions may be coupled to an edge of the center portion as one unit. The fixed membrane may include a second finger portion that may correspond to the first finger portions, and the fixed membrane may be bonded to the substrate. The penetration aperture may be communicated between the first finger and the second finger. The substrate may be made of material including a polysilicon or silicon on insulator wafer.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary embodiment of a cross-sectional view showing a microphone according to an exemplary embodiment of the present invention;

FIG. 2 is an exemplary embodiment of a top plan view showing the microphone according to an exemplary embodiment of the present invention;

FIG. 3 is an exemplary embodiment of a sectional views illustrating a method of manufacturing the microphone according to an exemplary embodiment of the present invention;

FIG. 4 is an exemplary embodiment of a sectional views illustrating a method of manufacturing the microphone according to an exemplary embodiment of the present invention;

FIG. 5 is an exemplary embodiment of a sectional views illustrating a method of manufacturing the microphone according to an exemplary embodiment of the present invention;

FIG. 6 is an exemplary embodiment of a sectional views illustrating a method of manufacturing the microphone according to an exemplary embodiment of the present invention; and

FIG. 7 is an exemplary embodiment of a sectional views illustrating a method of manufacturing the microphone according to an exemplary embodiment of the present invention.

### DETAILED DESCRIPTION OF THE EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

An exemplary embodiment of the present invention will hereinafter be described in detail with reference to the accompanying drawing.

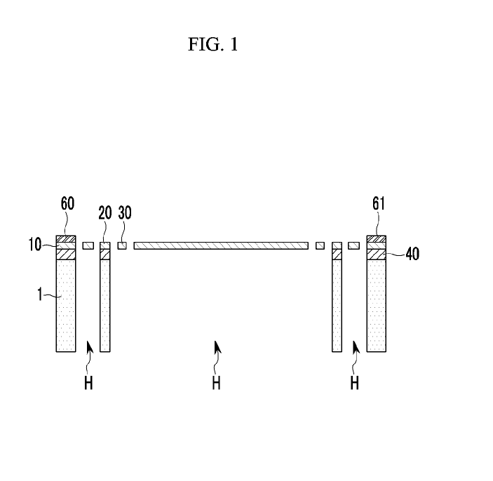

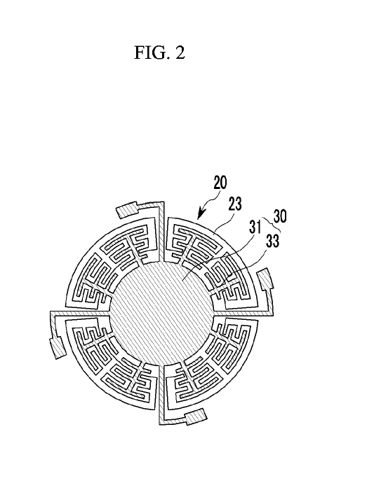

FIG. 1 is an exemplary cross-sectional view showing a microphone according to an exemplary embodiment, and FIG. 2 is an exemplary top plan view showing the microphone according to an exemplary embodiment. Referring to FIG. 1 and FIG. 2, a microphone according to an exemplary embodiment may include a substrate 1, and a membrane 10 which may further include a fixed membrane 20 and a vibrating membrane 30, formed as a substantially comb finger shape.

The substrate 1 may be made of polysilicon or silicon on insulator (SOI) wafer. Additionally, the substrate 1 may have at least one penetration aperture H, which includes an air inlet through which air may pass. The membrane 10 formed as the comb finger shape may be disposed on the substrate 1. The membrane 10 may include the fixed membrane 20 and the vibrating membrane 30, and may be formed having a substantially comb finger shape. The fixed membrane 20 and the vibrating membrane 30 may be disposed in a common layer (e.g., the same layer). The vibrating membrane 30 may be exposed by the penetration aperture H. Furthermore, the vibrating membrane may include a sustainably center portion 31 that may be formed in a center of the membrane 10 and a first finger portion 33.

Additionally, the fixed membrane 20 may include a second finger portion 33 that may be disposed between the first finger portions 33 corresponding to the first finger portion 33, and may be bonded to the substrate 1. The fixed membrane 20 and the vibrating membrane 30 will be discussed in further detail below. The first finger portion 33 may include a plurality of substantially straight portions which may extend radially outward from the center portion 31, and a plurality of extension portions which may extend in a plurality of cylindrical directions from the plurality of straight portions. Additionally, the second finger portion 23 may include an external portion that may be configured to enclose at least the two straight portions and an internal portion may extend from the inner side of the external portion. The internal portion and the extension portion may be disposed alternately.

The fixed membrane 20 and the vibrating membrane 30 are not limited to the above described shape, and may be realized various shapes including but not limited to a comb finger shape. As described, a structure of forming the fixed membrane 20 and vibrating membrane 30 in a common layer may reduce a size of the device, thereby downsizing the microphone as compared with the conventional art.

Moreover, the vibrating membrane 30 may be partially exposed by the penetration aperture H and a portion of the vibrating membrane 30 exposed by the penetration aperture H may be vibrated by sound from the exterior. The vibration originating from the vibrating membrane 30, may alter the gap between the vibrating membrane 30 and the fixed membrane 20 proximate to (e.g. adjacent) the vibrating membrane. Thus, the capacitance between the fixed membrane and the vibrating membrane may be changed. The changed capacitance may be converted into an electrical signal by a signal processing circuit (not shown) through a first pad 60 connected to the fixed membrane 20 and a second pad 61 connected to the vibrating membrane 30, enabling sound received from the exterior to be detected.

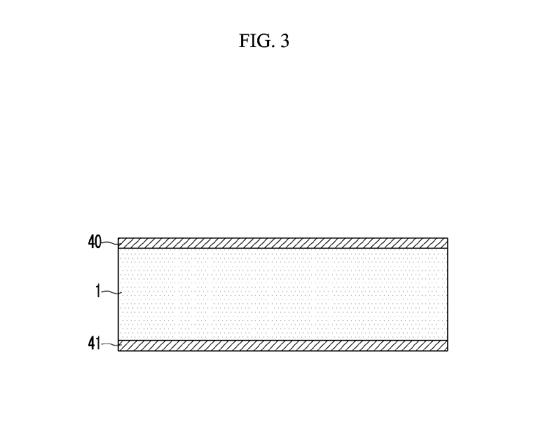

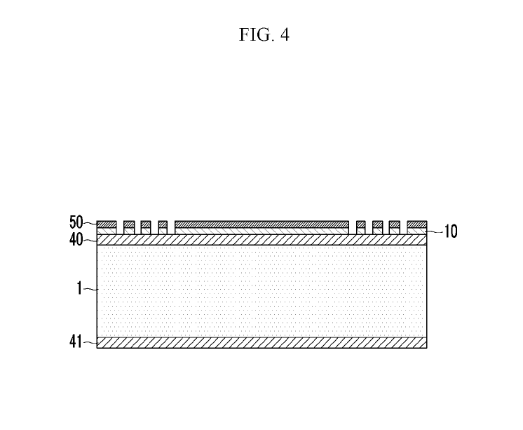

FIGS. 3 to 7 are sectional views illustrating a method of manufacturing the microphone based on an exemplary embodiment. Referring to FIG. 3, the substrate 1 may be prepared, and then a step of forming a first oxide film 40 on the substrate 1 and forming a second oxide film 41 under the substrate 1 may be performed. Referring to FIG. 4, the membrane 10 may be formed on the first oxide film and a first photosensitive layer pattern 40 may be formed on the membrane 10. The membrane 10 may be etched with the photosensitive layer pattern 50 as a mask, and thereby the fixed membrane 20 and the vibrating membrane 30 may be formed as a comb finger shape. For example, the fixed membrane 20 and the vibrating membrane 30 may be formed in a common layer. The structure of the microphone may be advantageous for preventing a device fail due to a drawing effect when a bias voltage is provided.

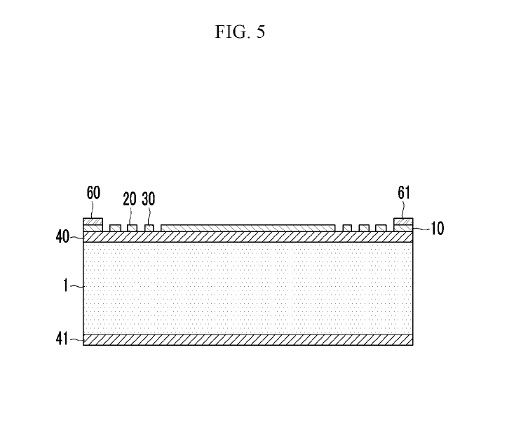

Referring to FIG. 5, a first pad 60 connected with the fixed membrane 20 and a second pad 61 connected with the vibrating membrane 30 may be individually formed after removing the first photosensitive layer pattern. Herein, the first pad 60 and the second pad 61 may be formed by a lift-off process.

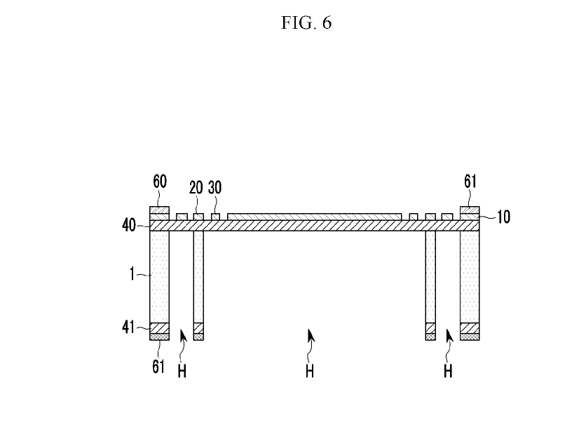

Referring to FIG. 6, a second photosensitive layer 41 may be formed on the second oxide 41 and a penetration aperture H may be formed by etching the substrate 1 with the second photosensitive layer pattern 51 as a mask. Herein, the penetration aperture H may be provided such that a part of the vibrating 30 may be exposed through penetration aperture H. Also, the penetration aperture H may include an air inlet through which air may pass therethrough. When a sound from the exterior flows through the interior into the penetration aperture H, the vibrating membrane 30 may vibrate.

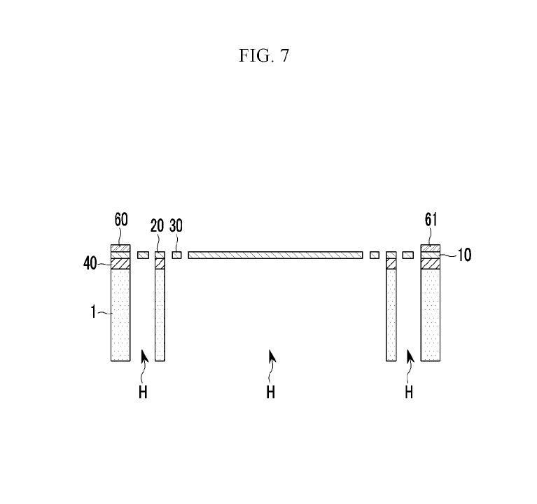

Referring to FIG. 7, the first oxide file 40 and the second oxide film 41 may be removed. The method of manufacturing the microphone according to an exemplary embodiment, may include utilizing four masks when the first photosensitive layer pattern 50, the second photosensitive layer pattern 51, the first pad 60, and the second pad 61 are formed. In other words, in order to manufacture the microphone, approximately ten masks may be required. However, in accordance with an exemplary embodiment, when the microphone is manufactured using four or an otherwise reduced number of masks, the number of processes may be reduced, and accordingly a process cost may be reduced. Furthermore, the number of process by friction may be reduced since removing of the sacrificial layer between films may be omitted.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A method of manufacturing a microphone, comprising:
forming a first oxide film and a second oxide film at an upper side and a lower side of a substrate respectively;
forming a membrane and a first photosensitive layer pattern sequentially over the first oxide film, and forming a vibrating membrane and a fixed membrane as a comb finger shape by etching the membrane with the first photosensitive layer pattern as a mask;
forming a second photosensitive layer pattern at the second oxide, and forming a penetration aperture by etching the substrate with the second photosensitive layer pattern as a mask; and
removing the first oxide film and the second film.

2. The method of claim 1, wherein in the forming of the vibrating membrane and the fixed membrane as the comb finger shape, the vibrating membrane and the fixed membrane are formed in a common layer.

3. The method of claim 1, further comprising:
after forming the vibrating membrane by etching the membrane, forming a first pad and a second pad coupled to the fixed membrane and the vibrating membrane after removing the first photosensitive layer pattern.

4. The method of claim 1, wherein the penetration aperture is formed to allow air to flow there through.

5. The method of claim 1, wherein the forming of a vibrating membrane by etching the membrane includes
forming a first pad and a second pad coupled with the fixed membrane and the vibrating membrane formed in a comb finger shape.

6. A microphone, comprising:
a substrate having at least one penetration aperture; and
a membrane disposed at an upper side of the substrate and having a vibrating membrane and the fixed membrane formed in a comb finger shape.

7. The microphone of claim 6, wherein the vibrating membrane and the fixed membrane are formed in a comb finger, and are disposed in a common layer.

8. The microphone of claim 6, wherein the vibrating membrane is exposed by the penetration aperture.

9. The microphone of claim 6, wherein the vibrating membrane includes,
a center portion formed in a center of the membrane; and
a plurality of first finger portions coupled to an edge of the center portion as one unit.

10. The microphone of claim 6, wherein the fixed membrane includes a second finger portion that corresponds to the first finger portions and bonds to the substrate.

11. The microphone of claim 10, wherein the penetration aperture is formed to allow a passage between the first finger and the second finger.

12. The microphone of claim 6, wherein the substrate is made of material including a polysilicon or silicon on insulator wafer.

13. The microphone of claim 6, wherein the vibrating membrane is partially exposed by the penetration aperture.

14. The microphone of claim 6, wherein a gap between the vibrating membrane and the fixed membrane is increased or decreased based on a movement of the vibrating membrane.
